(19) United States
(12) Patent Application Publication
(10) Pub. No.: US 2011/0049050 A1
(43) Pub. Date: Mar. 3, 2011

(54) METHOD OF CONTROLLING A SEPARATION UNIT HAVING A REVERSE OSMOSIS ELEMENT AND REVERSE OSMOSIS UNIT

(75) Inventor: Dirk Scheu, Amerdingen (DE)

(73) Assignee: KRONES AG, Neutraubling (DE)

(21) Appl. No.: 12/870,948

(22) Filed: Aug. 30, 2010

(30) Foreign Application Priority Data
Sep. 3, 2009 (DE) 102009040049.4

(51) Int. Cl. C02F 1/44; B01D 61/12

(52) U.S. Cl. 210/637; 210/88; 210/86

(57) ABSTRACT

A method of controlling a separation unit, having a reverse osmosis element, a raw water pump, a concentrate and permeate outlet conduit, where a predetermined yield is substantially kept constant, and where the raw water pump is controlled in response to a flow rate measurement of the raw water between the raw water pump and the reverse osmosis element.

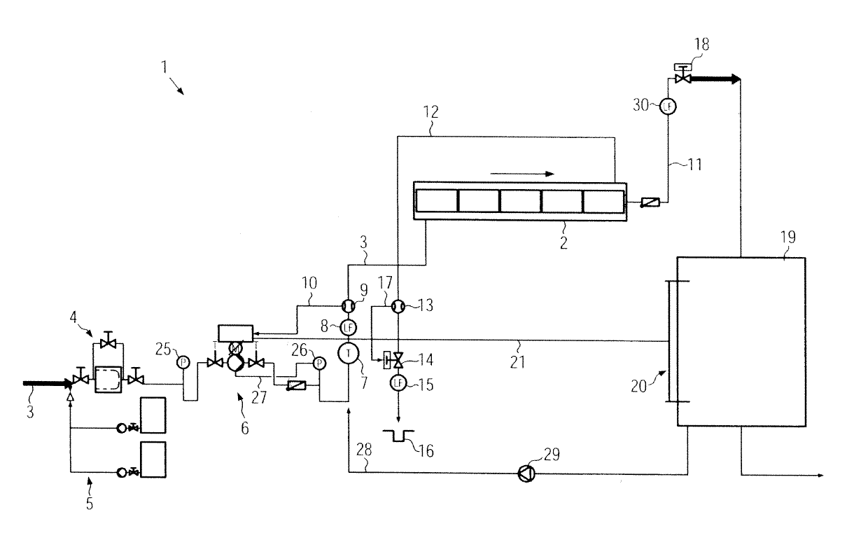

### CROSS-REFERENCE TO RELATED APPLICATION

The present application claims the benefit of priority of German Application No. 102009040049.4, filed Sep. 3, 2009. The entire text of the priority application is incorporated herein by reference in its entirety.

### FIELD OF THE DISCLOSURE

The disclosure relates to a method of controlling a separation unit having a reverse osmosis element and to such a separation unit.

A separation unit and a method of this type are known from WO 96/41675. The prior method is to be able to cope with changing work loads of the separation unit, namely with strongly varying raw water quantities, while simultaneously allowing a substantially constant yield, i.e. a predetermined ratio between permeate and concentrate. To this end, the flow of the concentrate is automatically adapted to the raw water influx, viz. in such a way that these two flows have and maintain a constant ratio relative to one another. Thus it is achieved that the recirculation of concentrate into the raw water influx is automatically adapted even if the utilization of capacity varies. The raw water influx is detected by a flow meter disposed upstream of the pump that provides for the filter pressure, i.e. ahead of this pump, and is used to control the flow cross-section and flow resistance in the concentrate outlet conduit. The capacity of the pump, however, remains unchanged, i.e. the pump is controlled to maintain a constant pressure. Although this step helps to achieve a constant yield apart of the pump's capacity is given away. This process is particularly fitted for units having smaller throughputs.

When the raw water pump is controlled to have a constant admission pressure, for instance, changes of the raw water temperature are not taken into account. If the raw water pump is controlled to still maintain a constant pressure although the raw water temperature has changed, the permeate and concentrate flow is either reduced or increased depending on the temperature change. As a consequence the yield is misaligned which, in an extreme case, may lead to abrupt precipitations of salt in the concentrate. These abrupt precipitations clog the membrane, which necessitates a time-consuming and laborious cleaning.

### SUMMARY OF THE DISCLOSURE

The disclosure has as one aspect to provide a method and a separation unit for reverse osmosis filtration, which allow in a constructively simple way to keep the yield constant despite, for instance, temperature and pressure variations in the inlet, without requiring to this end a buffer container for the forerun.

Moreover, by the quality-dependent rinsing of the unit with permeate not only water is saved, but also the quantity of used cleansing chemicals.

By controlling the raw water pump in accordance with the disclosure based on the flow generated by the pump it is ensured in a constructively simple and very effective and sensitive way that the permeation through the membrane can be kept constant without being dependent on external influences, no that a yield set in advance, i.e. a ratio of permeate quantity to concentrate quantity set in advance is obtained automatically and is kept constant. This is accomplished by keeping the influx quantity and concentrate quantity constant.

The yield can be varied by changing the flow cross-section of the concentrate conduit in response to a flow measurement performed in the conduit.

Furthermore, it is possible to vary the permeate quantity within a bandwidth in order to obtain, for instance, a level control for a permeate tank. This has the additional advantage that the reverse osmosis unit thus achieves optimum running times (shut down and start-up are minimized, thereby increasing the life cycle of the membrane).

Another advantage afforded by the unit according to the disclosure is a quality-dependent cleaning, with the cleaning success being actually monitored (and not being automatically assumed after a predetermined time lapse), which is preferably accomplished by a conductivity measurement in the concentrate outlet conduit. This measure cannot only be used for the disclosed separation unit and the disclosed method comprising a flow-controlled pump, but also for differently constructed separation units and methods.

### BRIEF DESCRIPTION OF THE DRAWING

An embodiment of the disclosure shall be explained in more detail below by means of a single drawing.

The FIGURE shows a schematic representation of a separation unit 1 according to the disclosure for performing the method according to the disclosure.

### DETAILED DESCRIPTION OF THE PREFERRED EMBODIMENT

The separation unit 1 comprises a conventionally constructed reverse osmosis element 2 having, for instance, a plurality of membranes, whose permeability is adjusted to the molecules to be filtered out. In the embodiment shown a single aggregate can be seen. The unit also works with the usual multiple aggregates, however.

The reverse osmosis element 2 is provided with the raw water to be filtered through a conduit 3. As is common, the raw water conduit 3 first passes a prefilter 4 in which coarser mechanical impurities are removed. At the same time, the hardness is stabilized by means of a correspondingly constructed device 5. The raw water then flows into a pump complex 6 which comprises an ordinary high-pressure pump with a frequency converter. The pump provides for the predetermined volume flow. After leaving the pump complex, the raw water flows via a temperature measuring means 7, a conductivity measuring means 8 into a commonly and optionally constructed flow meter 9. Preferably, the flow meter 9 is an inductive flow meter (IDM). The flow meter 9 is connected via a signal line 10 to the pump complex 6. Downstream of the flow meter the raw water flows into the reverse osmosis element 2.

A permeate conduit 11 for the cleaned water and a concentrate conduit 12 for salt-loaded liquid of an increased concentration come out of the reverse osmosis element 2. The concentrate conduit 12 continues via another flow meter 13, which again is preferably an inductive flow meter (IDM), a control valve 14 and a conductivity measuring means 15 until it reaches an outlet channel 16.

The flow meter 13 in the concentrate conduit 12 communicates with the control valve 14 by a signal line 17, so that the control valve 14 may be controlled in response to the flow measurement.

The permeate conduit 11 continues via a stop valve 18 until it reaches the consumer directly and/or a storage tank 19 in which permeate can be made available. The storage tank 19 is provided with a level gauge 20; represented are a lower and an upper level electrode. The level gauge is connected to pump 6 via a signal line 21.

During the operation of the separation unit 1 the desired yield (depending on the type and quantity of the substances contained in the raw water which are to be removed) and the flow required to generate an optimum permeation for obtaining the desired optimum yield are defined first. The operation of the unit is started, and the flow is monitored by the flow meter 9. If the flow rate changes, e.g. as a result of temperature changes in the raw water influx, the pump is controlled in such a way that the flow reassumes the predetermined value. In the present example this means that due to the temperature change in the raw water influx the viscosity thereof is varied. For instance, a lower temperature implies a higher viscosity of the raw water, which again implies a reduced volume flow being directly associated with the permeation through the membrane. A pump speed now controlled to be higher effects an increased volume flow and thus again a quantitatively balanced permeation through the membrane.

The separation unit according to the disclosure and the method according to the disclosure still function in a satisfactory manner even if the permeate quantity is varied for whatever reasons. The bandwidth for such a variation amounts to ±10 to 20%, which can thus for instance be used to maintain the tank 19 always at a certain filling level. The variations in the permeate quantity can be induced, for instance, by varying the flow cross-section and thus the outflow of concentrate through the concentrate conduit 12 by opening or closing the control valve 14 in an adjusted manner. This advantage over conventional systems particularly allows for smaller tank sizes because, as a result of the adaptation of the permeate quantity, faster reactions on varying conditions are feasible even downstream of the separation unit.

In a preferred embodiment the flow of the raw water is set at 29.4 m3/h at 10.5 bar at 12° C. With a yield of 85% this value results in an 85% share of permeate and a 15% share of concentrate, i.e. 25 m3/h of permeate at 0.3 bar positive pressure and 4.4 m3/h of concentrate at 7.7 bar positive pressure. If the temperature of the raw water changes, the flow meter maintains the flow rate of the raw water at the value at 12° C., that is, the flow is either reduced or increased, namely in such a way that the yield of 85% of permeate and 15% of concentrate remains constant (while, of course, the quantity of concentrate and permeate varies). This variation can be accomplished within a bandwidth of ±10 to 20%, so that the disclosed separation unit 1 can produce, for instance, between 20 and 31 m3/h of permeate without the yield of 85% undergoing a change. By this it is prevented in a simple way that the concentrate is overloaded and uncontrolled precipitations occur.

The separation unit according to the disclosure also allows for an improved cleaning. This cleaning can, however, also be used in other separation units not having a flow-controlled pump. According to the disclosure the cleaning is accomplished in a quality-dependent manner in response to the values measured by the conductivity measuring means 15 in the concentrate conduit 12. In this way it is reliably determined whether the liquid (concentrate/cleaning liquid/rinsing liquid) flowing off into channel 16 contains a sufficiently low salt content in order to be regarded a clean. By this it is ensured that all salts have been removed and that no residual salts are still in the system as a result of pressure fluctuations. This rinsing alternative saves rinsing liquid and prevents scaling and biofouling in out-of-service times.

The FIGURE shows other modifications which may be provided optionally. For instance, the FIGURE includes the possibility to switch the unit over to a conventional control. To this end, an admission pressure sensor 25 is provided upstream of pump 6, and a pressure sensor 26 is provided downstream of pump 6. The signals are transmitted via a signal line 27 to allow, if necessary, switching over to admission pressure detection by sensor 25 and to controlling the pressure of pump 6 by pressure sensor 26.

A second optional embodiment relates to the possibility to also rinse the unit with permeate, if necessary. To this end, the unit 1 is supplied by the pump 29 (frequency-controlled) via conduit 28 with permeate from the storage tank 19 (or another source). Conduit 28 leads into the raw water flow preferably upstream of temperature sensor 7. In this case, too, the rinsing result can be monitored by the conductivity measuring means in the concentrate conduit.

The quality control via the concentrate outlet conduit moreover permits a need-based predetermination of rinsing times during the operation. Thus, the optimum service life of the membrane is already determined during the operation so as to reduce already at this point scaling and biofouling caused by too long an operation. Furthermore, avoiding unnecessarily short cycles significantly increases the lifetime of the membrane by the all in all smaller cleaning load.

Moreover, another conductivity sensor 30 may be integrated in the permeate conduit 11, which affords an additional qualitative control of the quality-dependent rinsing with permeate. To this end, the measured conductivity values at conductivity sensors 8 and 30 can be compared. In case of rinsing with permeate, the rinsing thereafter via conduit path 28 and the frequency-controlled pump 29 takes place until the conductivity measurements of the sensors 8 and 30 are identical.

Hence, the separation unit provides for a quantity-dependent control of two volume flows, by means of which temperature and admission pressure fluctuations can be compensated. The intervention takes place on the raw water and concentration side, i.e. at reference numbers 9 (flow meter) and 13 (flow meter). Depending on the quality the rinsing may be accomplished with permeate and chemical substances. As compared to conventional, time-controlled rinsing (which is either too short or too long) this rinsing saves water and cleaning agents. Scaling and biofouling are reduced because the rinsing takes not too long. The lifetime of the membrane is prolonged as the cleaning takes place not too often and only when necessary, and only for the necessary length of time. If needed, a switching to conventional control may be performed. The bandwidth of the disclosed unit permits the compensation of raw water fluctuations. Moreover, the filling level in the buffer tank can thus be controlled. Therefore, the same may be smaller than usual. It is an advantage if no excessively great quantities have to be stored in the buffer tank (permeate tank).

The disclosure is not limited to the described and illustrated embodiment. The flow-controlled pump can, for instance, also be used in other separation units with other membranes and/or other combinations of membranes. The storage tank including its level control need not necessarily be connected to the pump, but may be controlled separately on the basis of request signals coming from outside the separation unit. Also, the separation unit may comprise any standard and useful components not shown in the FIGURE.

1. Method of controlling a separation unit having a reverse osmosis element, a raw water pump, a concentrate and permeate outlet conduit, wherein a predetermined yield is substantially kept constant, comprising that for keeping the yield constant controlling the capacity of the raw water pump in response to a flow rate measurement of the raw water between the raw water pump and the reverse osmosis element.

2. Method according to claim 1, and varying the flow cross-section of the concentrate conduit in response to a flow measurement in the concentrate conduit.

3. Method according to claim 1, comprising varying the permeate quantity.

4. Method according to claim 1, and controlling the capacity of the raw water pump by a level measuring means detecting a filing level in a permeate reservoir.

5. Method according to claim 1, and rinsing the unit in response to a measurement of the conductivity in the concentrate.

6. Separation unit, comprising a reverse osmosis element, a raw water pump, a permeate outlet conduit, a concentrate outlet conduit and a flow metering element, and the flow metering element is disposed between the raw water pump and the reverse osmosis element and is connected to the raw water pump.

7. Separation unit according to claim 6, and a flow rate meter and a control valve controlled by the same are disposed in the concentrate conduit.

8. Separation unit according to claim 6, wherein the permeate conduit is connected to a storage tank provided with a level gauge and that the level gauge is connected to the raw water pump.

9. Separation unit according to claim 6, and a conductivity measuring means is provided in the concentrate outlet conduit.

10. Method according to claim 3, and varying the permeate quantity within a bandwidth of ±10 to 20%.
